(19) United States
(12) Patent Application Publication
(10) Pub. No.: US 2015/0275868 A1
(43) Pub. Date: Oct. 1, 2015

(54) PLASMA ION ENGINE

(71) Applicant: LA YAOMEI INT'L GROUP, INC., Los Angeles, CA (US)

(72) Inventor: JIMMY SABORI, San Jose, CA (US)

(73) Assignee: LA YAOMEI INT'L GROUP, INC., Los Angeles, CA (US)

(21) Appl. No.: 14/206,261

(22) Filed: Mar. 12, 2014

Related U.S. Application Data
(60) Provisional application No. 61/838,455, filed on Jun. 24, 2013.

(51) Int. Cl. F03H 1/00

(52) U.S. Cl. CPC F03H 1/0037

(57) ABSTRACT

A method of operating a plasma ion engine includes the steps of providing a mechanical engine having a vacuum in a chamber of the mechanical engine; injecting inert gases into the chamber of the mechanical engine; providing a pulse of electrical spark into the chamber of the mechanical engine; creating an electromagnetic field from the phase change of the inert gas; applying a high frequency radio signal into the chamber of the mechanical engine before and during the phase change of the inert gas; providing an anode and cathode interaction across the chamber; providing tantalum plates in the chamber; and receiving a portion of the electromagnetic field in the capacitors.

The present invention claims priority from and is a non-provisional application of provisional application by inventor Jimmy Sabori, and applicant LA YAOMEI INT'L GROUP, INC. entitled Plasma Ion Engine, 61/838,455 filed Jun. 24, 2013 the disclosure of which is incorporated herein by reference.

### FIELD OF THE INVENTION

The present invention is in the field of plasma ion engines.

### DISCUSSION OF RELATED ART

Traditionally, combustion has powered internal combustion engines. Combustion changes a liquid to a gas while changing the liquid's chemical composition. Engines can also be powered by phase change of a gas to plasma. Plasma engines have the benefit of being self-contained and not having fossil carbon emissions. Gas can have ionic properties allowing electrical flow through the gas which may convert it momentarily to plasma and back again to guess. An example of gas to plasma conversion through gas having and properties is lightning.

A variety of different engines have used plasma production to provide a phase change for driving the engine. A piston can be driven by converting an inert gas catalyst mixture into plasma. Papp in U.S. Pat. No. 4,428,193 issued Jan. 31, 1984 entitled Inert Gas Fuel, Fuel Preparation Apparatus And System For Extracting Useful Work From The Fuel describes has an internal combustion engine that uses an inert gas mixture for producing a plasma that provides a phase change to drive an engine. For example, international publication WO1996012879 is entitled Ion Electromagnetic Engine, filed Oct. 16, 1995, by inventor Jimmy Sabori, the disclosure of which is incorporated herein by reference.

### SUMMARY OF THE INVENTION

A method of operating a plasma ion engine includes the steps of providing a mechanical engine having a vacuum in a chamber of the mechanical engine; injecting inert gases into the chamber of the mechanical engine; providing a pulse of electrical spark into the chamber of the mechanical engine; creating an electromagnetic field from the phase change of the inert gas; applying a high frequency radio signal into the chamber of the mechanical engine before and during the phase change of the inert gas; providing an anode and cathode interaction across the chamber; providing tantalum plates in the chamber; and receiving a portion of the electromagnetic field in the capacitors.

The method optionally includes the step of injecting inert gases into the chamber of the mechanical engine, wherein the inert gases include Helium, Neon, Argon, Krypton and Xenon. A capacitor can be provided for inducing a phase change of the inert gas. A timed pulse of energy can be provided to the ignition coil, and the timed pulse of energy is preferably between 1 nanosecond and 1.5 nanoseconds.

A radio frequency generator can introduce a high frequency radio pulse on the ignition coil such that the frequency of the radio pulse in megahertz is equivalent to the ignition coil voltage in volts. The method may include the step of forming anode containers and cathode containers on the anode and cathode. The method may include the step of making the anode and cathode containers of aluminum, wherein the aluminum anode container contains rubidium and phosphorus in argon gas and is topped with mineral oil as a sealant. The cathode container may contain a negative charge and is filled with a thorium in mineral oil as a sealant. The method may include the step of mounting condenser plates behind the firing tips of the electrodes. The condenser plates can be made of tungsten. An engine computer can control cylinder coils mounted around the circumferential periphery of the chamber. It is an object of the present invention to improve on previous methods.

### BRIEF DESCRIPTION OF THE DRAWINGS

FIG. 1 is a diagram of the present invention.

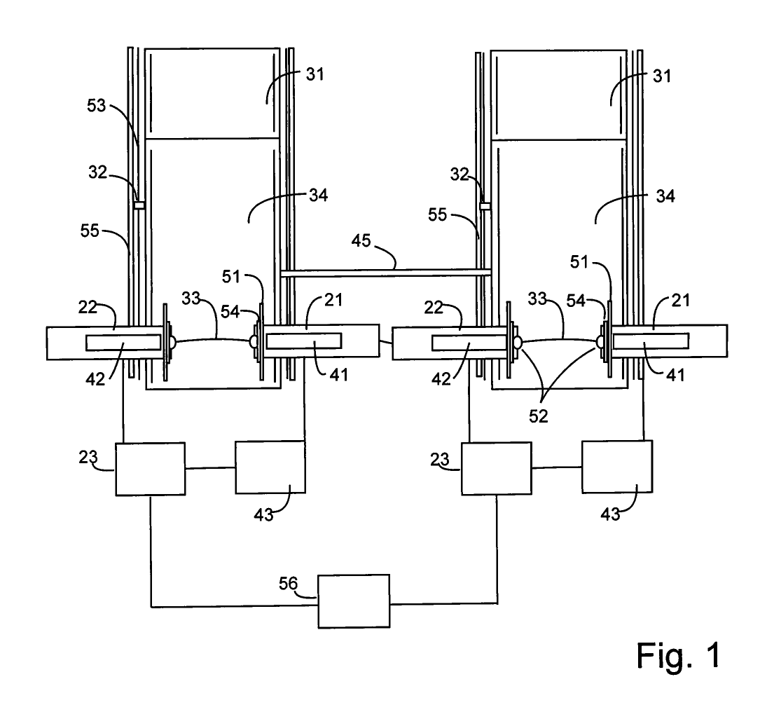

The following call out list of elements can be a useful guide in referencing the elements of the drawings.
21 Anode
22 Cathode
23 Capacitor Circuit
31 Piston
32 Filling Valve
33 Arc
34 Piston Firing Chamber
41 Anode Container
42 Cathode Container
43 Radio Frequency Generator
45 Piston Firing Chamber Connection
51 Tantalum Condenser Plates
52 Tungsten Firing Tip
53 Non-Magnetic Sleeves
54 Firing Coil
55 Thee Sets of Cylinder Coils
56 Engine Computer

### DETAILED DESCRIPTION OF THE PREFERRED EMBODIMENT

The present invention does not use combustible fuel in a standard internal combustion engine. Beginning with a standard internal combustion engine, the internal combustion chamber is taken to near total vacuum measuring −30″ Hg into which a user injects ionized inert gases, also known as the Noble Gases. As a preliminary disclaimer, it may appear to a casual outside observer that this inert ion drive is over unity; however the present invention is not a perpetual motion machine. Although inert gases are in total equilibrium and cannot produce “work” the release of heat and expansion by the ionized gases to the piston heads 31 transforms the phase change to kinetic energy (energy of motion) that will move the piston heads to create work. The energy is transferred between pistons. The ionization of inert gases is best done by a formulation and with a gas lab specifically developed for the ionization of inert gases.

A near total vacuum is first created. Before injecting any inert gases into the piston firing chamber 34 of the engine a near total, leak proof state of vacuum must be maintained in the piston chamber. A ½ (one half) to ¾ (three quarter) horsepower vacuum pump can easily pull a vacuum down to negative 30 inches of Mercury (−30″ Hg) and/or “0” inches of pressure. A vacuum gauge measures the vacuum inside the gas chamber of the engine. The vacuum gauge should read near −30″ Hg. This same gauge should read close to or less than −30″ Hg when the ionized inert gases are injected into the gas chamber of each of the two pistons of a two piston engine. The piston has a filling valve 32 that provides a port for introducing or flushing gases. For example, if 100 ccs or 6 cubic inches of ionized inert gases are to be injected into the piston chamber, the vacuum gauge should drop to indicate −15″ Hg. After injection, it may be helpful to think of the piston chamber as having 50% of the volume of the piston chamber filled by inert gases and 50% of the volume of the piston chamber remaining a vacuum since the inert gases in the vacuum chamber, by nature of being inert, remain separate while occupying the same space within the vacuum chamber. The vacuum within the chamber will absorb a significant amount of the explosive thrust of the power of the ionized inert gases against the piston head to cushion the work by providing resistance to the piston head. The resistance from the vacuum can be calibrated to draw the piston back into firing position.

Inert gases used within the engine can be Helium (HE 2), Neon (NE 10), Argon (AR 18), Krypton (KR 36) and Xenon (XE 54). It is preferred to avoid radon gas due to its radioactive and potentially dangerous nature. An electrical spark input pulse provides excitation of the inert gases for the ionization process. An electrical spark can be created across the electrodes supplied by a 12 volt (12 V.D.C) battery to an ignition coil 54, similar to the ignition spark plug in a combustion engine. As a result of outside influence (ie: ionization excitation) gas ions and electrons are created and are in a state of non-equilibrium. The expansion of the gas started as an arc 33 expands to a plasma ball to provide a phase change for driving the piston.

The phase change of the gas to plasma provides a magnetically excited reaction. Magnetic fields produce densification of the gases. The input voltage to the coils which surround the piston firing chamber is proportional to the flux, which can be measured in gauss by a flux measurement monitor. During the power stroke of the piston, power can come from a pair of 12 volt batteries, in series, for a total of 24 volts of direct current. Alternatively, the piston can receive power from a photovoltaic direct current. If sufficient current is supplied to the coils such as 1000 V from the capacitor, the gases will constrict in the center of the piston chamber to form a plasma. At the same time that the capacitor discharges 1,000 V into the coils and the anode 21 and cathode 22, the ignition coil provides an additional discharge of 40,000 volts to the electrodes resulting in a tremendous release of energy. The temperature of the plasma may reach 1.5 million degrees Fahrenheit for a nanosecond. The short time of superheated plasma should be calibrated in length. Less than a nanosecond will not be effective in the operation of the engine and more than a nanosecond will damage the cylinder walls and the electrodes 21, 22.

A high frequency radio pulse can be input on the ignition coil at 26,242 megahertz (MHz) when the ignition coil is at 26,242 volts DC. Such that the megahertz is equivalent to the ignition coil voltage. A series of high frequency radio pulses can be output into the ignition chamber for excitation of plasma molecules. A radio frequency generator 43 can be connected to the anode and cathode. Optionally, the piston chambers have a piston chamber firing connection 45.

The plasma generation is from anode and cathode interaction which is generated from anode containers 41 and cathode containers 42. The anode and cathode containers are made of pure aluminum without any alloys. The aluminum anode container carries a positive (+) charge and is filled with ½ gram of rubidium (Rb-37) and ½ gram of phosphorus (P-15) in argon gas and topped with mineral oil as a sealant. The cathode container carries a negative (−) charge and is filled with a gram of Thorium (TH-232) in mineral oil as a sealant. Both of the containers are then connected to the terminals (+ and −) of the energy source (the capacitors). They receive their current from the electrodes and capacitors of the other cylinder.

Two condenser plates 51 are made of Tantalum (TA-73) and mounted behind the Tungsten firing tips 52 of the electrodes. The two condenser plates appear like mirrors facing each other. The plates are directly in the path of the cathode rays. The condenser plates may reflect the cathode rays converting the cathode rays to low radiating x-rays. These x-rays can be formed when the high speed electrons from the cathode are slowed down when they impact on the Tantalum plates. Their potential energy can be converted partially to heat and partially to x-rays. These newly created x-rays possess greatly excited energy. Their naturally occurring electro-magnetic properties help to create this reaction.

Three sets of cylinder coils 55 are stacked one on top of the other and activated sequentially by the engine computer 56 which has been programmed to control the charging of the coils. Cylinder sleeves surrounding the coils for the purpose of stabilizing the coils from the movement of the pistons, must be made of non-magnetizable and heat resistant material. The three magnetic coils are made and wound of 19 gauge wire with approximately 1,050 turns and 100 MHz induction. One or more Teflon rings act as guides to maintain the correct position of the pistons within the sleeves.

There is also a method for reverse current polarization. When the piston reaches bottom dead center BDC the three coils are de-energized immediately followed by the top and bottom coils being reenergized with the opposite polarity causing a reversal in the magnetic field. This causes the gas layering and a vertical spinning movement. As the gas layers move through the magnetic field electricity is induced in the argon layer which acts as a conductor. The positive electrodes in the head are designed to protrude into the argon layer which picks up the electrical current and directs the current to the capacitors which store the energy until it can be used to fire the next cylinder. The reversal of the electromagnetic field at BDC facilitates the collapse of the pressure wave and assists the piston in moving back towards top dead center TDC. As the piston approaches TDC the vertical spinning movement of the gases returns to a horizontal spinning motion in the confined toroidal space of the combustion chamber. Since the cylinders are sealed and closed there are no emissions expelled from the engine.

A pair of capacitors can be configured with the pistons encased within the non-magnetic sleeves 53. The piston sleeves are surrounded or encased by a second non-magnetic sleeve which is the capacitor. These secondary sleeves are made of a layer of aluminum foil followed by a layer of Mylar until it is approximately ¾″. The Mylar should be of sufficient thickness to prevent a short circuit by the aluminum sheets.

Each capacitor preferably has a pair of poles which project inwardly into the cylinder. A pair of capacitors can be used in capacitor circuit 23. For example, the top capacitor can be loaded to 400 volts D.C. and the bottom capacitor is loaded to 600 volts D.C. for a total combined loaded voltage of 1,000 V.D.C. At the prescribed or programmed timing, both capacitors release the loaded voltage of 1,000 V.D.C. to the anode and cathode of their respective piston. They can give up a charge or store a charge until needed. Preferably, solid state capacitors can be used and can be more reliable than the above described capacitors. The capacitor capacitance as measured in farads would be calculated by multiplying one amp with a millisecond and dividing by 1000 V to provide 1 F of capacitance for the top and bottom capacitors together. This equates to 0.4 F of capacitance for the top capacitor and 0.6 F for the bottom capacitor. Amperage may be adjusted, such as being increased.

1. A method of operating a plasma ion engine comprising the steps of:
a. providing a mechanical engine having a vacuum in a chamber of the mechanical engine;
b. injecting inert gases into the chamber of the mechanical engine;
c. providing a pulse of electrical spark into the chamber of the mechanical engine;
d. creating an electromagnetic field from the phase change of the inert gas;
e. applying a high frequency radio signal into the chamber of the mechanical engine before and during the phase change of the inert gas;
f. providing an anode and cathode interaction across the chamber;
g. providing tantalum plates in the chamber; and
h. receiving a portion of the electromagnetic field in the capacitors.

2. The method of claim 1, further comprising the step of:
a. injecting inert gases into the chamber of the mechanical engine, wherein the inert gases include Helium, Neon, Argon, Krypton and Xenon.

3. The method of claim 1, further comprising the step of: providing a capacitor for inducing a phase change of the inert gas.

4. The method of claim 1, further comprising the step of: providing a timed pulse of energy to the ignition coil, wherein the timed pulse of energy is between 1 nanosecond and 1.5 nanoseconds.

5. The method of claim 1, further comprising the step of: introducing a high frequency radio pulse on the ignition coil such that the frequency of the radio pulse in megahertz is equivalent to the ignition coil voltage in volts.

6. The method of claim 1, further comprising the step of: forming anode containers and cathode containers on the anode and cathode.

7. The method of claim 6, further comprising the step of: making the anode and cathode containers of aluminum, wherein the aluminum anode container contains rubidium and phosphorus in argon gas and is topped with mineral oil as a sealant. The cathode container contains a negative charge and is filled with a thorium in mineral oil as a sealant.

8. The method of claim 1, further comprising the step of: mounting condenser plates behind the firing tips of the electrodes.

9. The method of claim 8, further comprising the step of: forming the condenser plates of tungsten.

10. The method of claim 1, further comprising the step of: including and using an engine computer to control cylinder coils mounted around the circumferential periphery of the chamber.

11. The method of claim 10, further comprising the step of:
a. injecting inert gases into the chamber of the mechanical engine, wherein the inert gases include Helium, Neon, Argon, Krypton and Xenon.

12. The method of claim 10, further comprising the step of providing a capacitor for inducing a phase change of the inert gas.

13. The method of claim 10, further comprising the step of: providing a timed pulse of energy to the ignition coil, wherein the timed pulse of energy is between 1 nanosecond and 1.5 nanoseconds.

14. The method of claim 10, further comprising the step of: introducing a high frequency radio pulse on the ignition coil such that the frequency of the radio pulse in megahertz is equivalent to the ignition coil voltage in volts.

15. The method of claim 10, further comprising the step of: forming anode containers and cathode containers on the anode and cathode.

16. The method of claim 15, further comprising the step of: making the anode and cathode containers of aluminum, wherein the aluminum anode container contains rubidium and phosphorus in argon gas and is topped with mineral oil as a sealant. The cathode container contains a negative charge and is filled with a thorium in mineral oil as a sealant.

17. The method of claim 10, further comprising the step of: mounting condenser plates behind the firing tips of the electrodes.

18. The method of claim 17, further comprising the step of: forming the condenser plates of tungsten.
